(19) United States
(12) Patent Application Publication
(10) Pub. No.: US 2026/0275764 A1
(43) Pub. Date: Sep. 17, 2026

(54) REKEYABLE LOCK

(71) Applicant: TAIWAN FU HSING INDUSTRIAL CO., LTD., Kaohsiung City (TW)

(72) Inventor: TIEN-FU CHAN, Kaohsiung City (TW)

(21) Appl. No.: 19/385,095

(22) Filed: Nov. 10, 2025

(30) Foreign Application Priority Data
Nov. 21, 2024 (TW) 113144968

(51) Int. Cl. E05B 27/00

(52) U.S. Cl. CPC E05B 27/005

(57) ABSTRACT

A lock includes a lock casing formed with a lock cylinder hole, a plurality of first pin holes and a plurality of setting holes; and a lock cylinder rotatably arranged in the lock cylinder hole and formed with a plurality of second pin holes. When the lock cylinder is located at a first rotating position relative to the lock casing, the second pin holes are aligned with the first pin holes respectively. When the lock cylinder is rotated relative to the lock casing from the first rotating position to a second rotating position, the second pin holes face toward and are misaligned with the setting holes respectively. When the lock cylinder is located at the second rotating position and further moved from a first axial position to a second axial position along an axial direction of the lock cylinder, the second pin holes are aligned with the setting holes respectively.

### BACKGROUND OF THE INVENTION

### FIELD OF THE INVENTION

The present invention relates to a lock, and more particularly, to a rekeyable lock.

### DESCRIPTION OF THE PRIOR ART

Generally, a lock comprises a plurality of pins in a lock cylinder to work with a key in order to perform locking and unlocking operations. For example, when heights of teeth of the key correspond to variances in length of the pins in the lock cylinder, the key can rotate the lock cylinder to perform locking and unlocking operations; when heights of teeth of the key does not correspond to variances in length of the pins in the lock cylinder, the key cannot rotate the lock cylinder to perform locking and unlocking operations. For requirements of replacing the key, the pins in the lock cylinder of the prior art must be replaced, such that heights of teeth of a new key correspond to variances in length of new pins in the lock cylinder. However, processes of replacing the pins in the cylinder of the prior art is highly complex, thereby increasing inconvenience of use.

### SUMMARY OF THE INVENTION

A rekeyable lock comprises a lock casing formed with a lock cylinder hole, a plurality of first pin holes and a plurality of setting holes; a lock cylinder rotatably arranged in the lock cylinder hole and formed with a plurality of second pin holes; and a pin set comprising a plurality of first pins accommodated in the plurality of first pin holes respectively, a plurality of second pins accommodated in the plurality of second pin holes respectively, and a plurality of setting pins. Each of the setting holes is configured to accommodate a predetermined number of setting pins. When the lock cylinder is located at a first rotating position relative to the lock casing, the plurality of second pin holes are aligned with the plurality of first pin holes respectively. When the lock cylinder is rotated relative to the lock casing from the first rotating position to a second rotating position, the plurality of second pin holes face toward and are misaligned with the setting holes respectively, so as to prevent the plurality of setting pins from being moved between the plurality of setting holes and the plurality of second pin holes. When the lock cylinder is located at the second rotating position and further moved relative to the lock casing from a first axial position to a second axial position along an axial direction of the lock cylinder, the plurality of second pin holes are aligned with the setting holes respectively, so as to allow the plurality of setting pins to be moved between the plurality of setting holes and the plurality of second pin holes.

In one embodiment of the present invention, the rekeyable lock further comprises a positioning piece movably arranged on the lock cylinder, and the lock casing is formed with a groove. When the lock cylinder is located at the first rotating position relative to the lock casing, the positioning piece is configured to be engaged with the groove to prevent the lock cylinder from being rotated relative to the lock casing.

In one embodiment of the present invention, the rekeyable lock further comprises a positioning ring arranged on the lock cylinder. The positioning ring is formed with a protrusion part. When the lock cylinder is located at the first rotating position relative to the lock casing, the protrusion part is configured to abut against the lock casing to prevent the lock cylinder from being moved relative to the lock casing from the first axial position to the second axial position along the axial direction of the lock cylinder.

In one embodiment of the present invention, when the lock cylinder is located at the second rotating position relative to the lock casing, the protrusion part corresponds to the groove to allow the lock cylinder to be moved relative to the lock casing from the first axial position to the second axial position along the axial direction of the lock cylinder.

In one embodiment of the present invention, the rekeyable lock further comprises a positioning piece movably arranged on the lock cylinder, and the lock casing is formed with a groove. When the lock cylinder is located at the second rotating position and the second axial position relative to the lock casing, the positioning piece is configured to be engaged with the groove to prevent the lock cylinder from being rotated relative to the lock casing.

In one embodiment of the present invention, the lock cylinder is further formed with a keyhole communicated with the plurality of second pin holes. When the lock cylinder is located at the second rotating position and the second axial position relative to the lock casing and when a key is inserted into the keyhole to abut against the positioning piece, the positioning piece is configured to be driven to disengage from the groove.

In one embodiment of the present invention, the lock cylinder is further formed with a plurality of anti-theft grooves respectively communicated with the plurality of second pin holes. A maximum dimension of the anti-theft groove along the axial direction of the lock cylinder is smaller than a maximum dimension of the second pin hole along the axial direction of the lock cylinder.

In one embodiment of the present invention, the setting pin comprises a top part and a bottom part. A maximum dimension of the top part along the axial direction of the lock cylinder is greater than the maximum dimension of the anti-theft groove along the axial direction of the lock cylinder, and a maximum dimension of the bottom part along the axial direction of the lock cylinder is not greater than the maximum dimension of the anti-theft groove along the axial direction of the lock cylinder.

In one embodiment of the present invention, the pin set further comprises a plurality of pin springs respectively accommodated in the plurality of first pin holes and configured to push the plurality of first pins to move toward the lock cylinder.

In one embodiment of the present invention, the pin set further comprises a plurality of setting springs respectively accommodated in the plurality of setting holes and configured to push the plurality of setting pins to move toward the lock cylinder.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a rekeyable lock of the present invention.

FIG. 2 is an exploded view of the rekeyable lock of the present invention.

FIG. 3 is a cross-sectional view of a lock cylinder of the rekeyable lock of the present invention located at a first rotating position before a key being inserted into a keyhole of the lock cylinder.

FIG. 4 is a cross-sectional view of the lock cylinder of the rekeyable lock of the present invention located at the first rotating position after the key being inserted into the keyhole of the lock cylinder.

FIG. 5 is a diagram showing the lock cylinder of the rekeyable lock of the present invention located at the first rotating position in another viewing angle.

FIG. 6 is a diagram showing the lock cylinder of the rekeyable lock of the present invention being rotated from the first rotating position to a second rotating position.

FIG. 7 is a cross-sectional view of the lock cylinder of the rekeyable lock of the present invention located at the second rotating position and a first axial position.

FIG. 8 is a diagram showing the lock cylinder of the rekeyable lock of the present invention located at the second rotating position and a first axial position in another viewing angle.

FIG. 9 is a diagram showing the lock cylinder of the rekeyable lock of the present invention located at the second rotating position and a second axial position.

FIG. 10 is a cross-sectional view of the lock cylinder of the rekeyable lock of the present invention located at the second rotating position and the second axial position.

FIG. 11 is a cross-sectional view of the lock cylinder of the rekeyable lock of the present invention located at the second rotating position and the second axial position with the key being removed from the keyhole.

FIG. 12 is a diagram showing a lock casing and a positioning piece of the rekeyable lock of the present invention.

FIG. 13 is a diagram showing the lock cylinder and setting pins of the present invention.

FIG. 14 is a diagram showing the lock cylinder and the setting pins of the present invention in another viewing angle.

### DETAILED DESCRIPTION

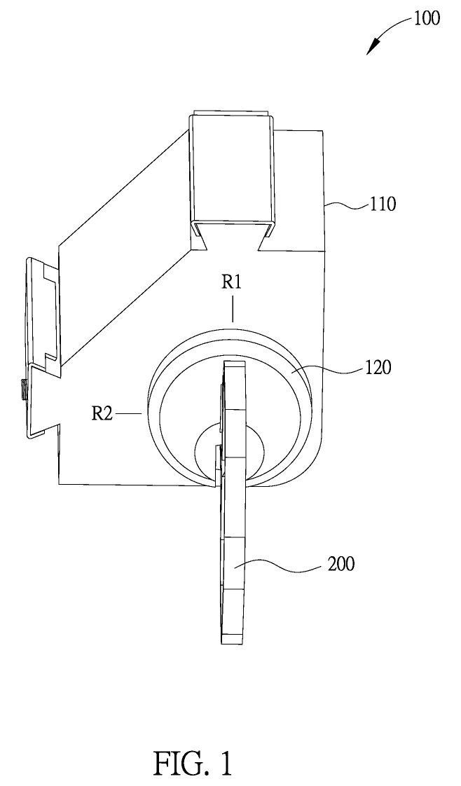

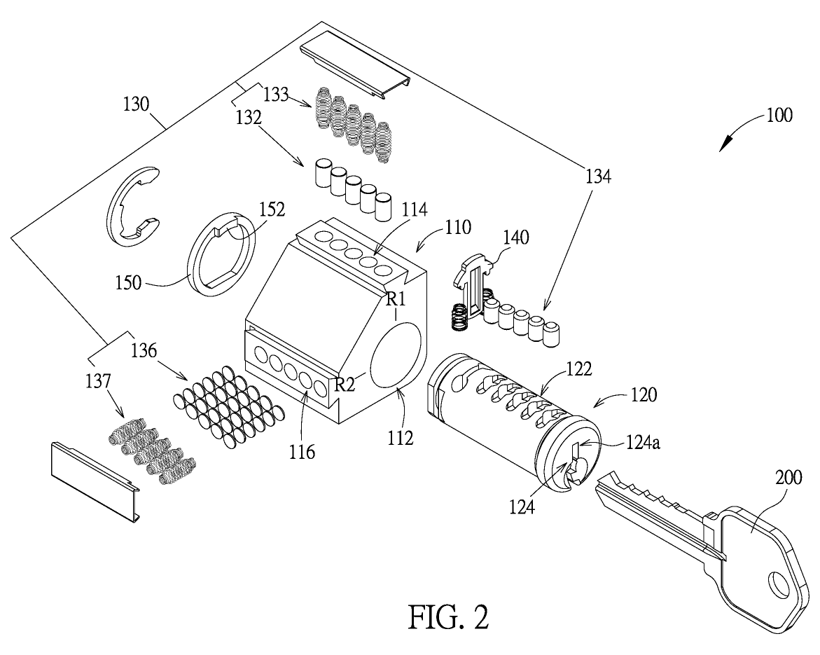

Please refer to FIGS. 1 and 2 and FIG. 2. FIG. 1 is a diagram showing a rekeyable lock of the present invention. FIG. 2 is an exploded view of the rekeyable lock of the present invention. As shown in the figures, the rekeyable lock 100 of the present invention comprises a lock casing 110, a lock cylinder 120 and a pin set 130. The lock casing 110 is formed with a lock cylinder hole 112, a plurality of first pin holes 114 and a plurality of setting holes 116. The lock cylinder hole 112 is communicated with the first pin holes 114 and the setting holes 116. The lock cylinder 120 is rotatably arranged in the lock cylinder hole 112. The lock cylinder 120 is formed with a plurality of second pin holes 122, and a keyhole 124 communicated with the plurality of second pin holes 122. The keyhole 124 is configured to allow a key 200 to be inserted therein. As shown in FIG. 1, the lock cylinder 120 is located at a first rotating position R1 relative to the lock casing 110 (a top part 124a of the keyhole 124 (shown in FIG. 2) corresponds to the first rotating position R1).

The pin set 130 comprises a plurality of first pins 132, a plurality of second pins 134, and a plurality of setting pins 136. The plurality of first pins 132 are accommodated in the plurality of first pin holes 114 respectively. The plurality of second pins 134 are accommodated in the plurality of second pin holes 122 respectively. Lengths of the plurality of first pins 132 are identical, and lengths of the plurality of second pins 134 are identical. The setting pins 136 are accommodated in the setting holes 116, and each of the setting holes 116 is configured to accommodate a predetermined number of the setting pins 136. In the present embodiment of the present invention, each of the setting holes 116 is configured to accommodate six setting pins 136, but the present invention is not limited to thereto. In addition, the pin set 130 further comprises a plurality of pin springs 133 and a plurality of setting springs 137. The plurality of pin springs 133 are respectively accommodated in the plurality of first pin holes 114 and configured to push the plurality of first pins 132 toward the lock cylinder 120. The plurality of setting springs 137 are respectively accommodated in the plurality of setting holes 116 and configured to push the plurality of setting pins 136 toward the lock cylinder 120. During setting of the rekeyable lock 100, the setting pins 136 can be moved to the second pin holes 122 of the lock cylinder 120 to be further accommodated in the second pin holes 122, such that a total length of the second pin 134 and the setting pin(s) 136 in each of the second pin holes 122 corresponds to a height of a corresponding tooth of the key 200.

Furthermore, the rekeyable lock 100 of the present invention further comprises a positioning piece 140 and a positioning ring 150. The positioning piece 140 is movably arranged on the lock cylinder 120. The positioning ring 150 is fixedly arranged on the lock cylinder 120.

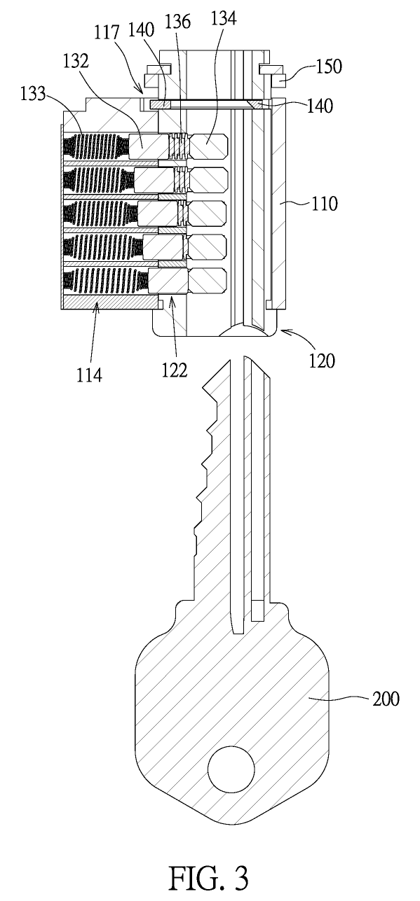

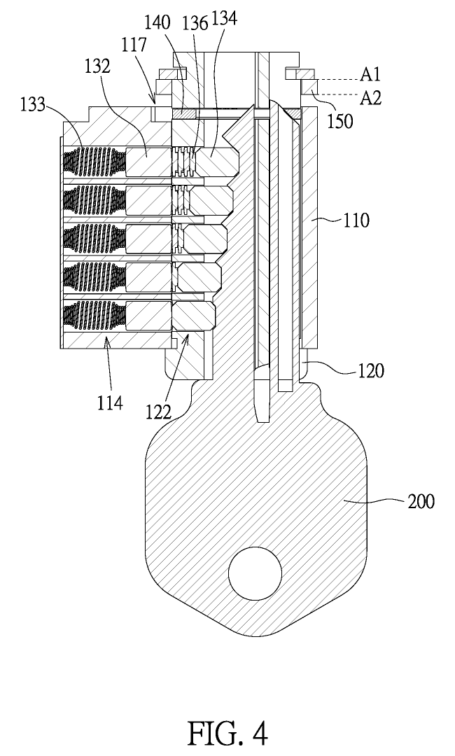

Please refer to FIG. 3 and FIG. 4, and refer to FIG. 1 and FIG. 2 as well. FIG. 3 is a cross-sectional view of the lock cylinder 120 of the rekeyable lock 100 of the present invention located at the first rotating position R before the key 200 being inserted into the keyhole 124 of the lock cylinder 120. FIG. 4 is a cross-sectional view of the lock cylinder 120 of the rekeyable lock 100 of the present invention located at the first rotating position R1 after the key 200 being inserted into the keyhole 124 of the lock cylinder 120. As shown in figures, when the lock cylinder 120 is located at the first rotating position R1 relative to the lock casing 110, the plurality of second pin holes 122 are aligned with and communicated with the plurality of first pin holes 114 respectively. When the key 200 is not yet inserted into the keyhole 124, the pin springs 133 are configured push the first pins 132 toward the lock cylinder 120, so as to allow the first pins 132 to extend into the second pin holes 122 of the lock cylinder 120, in order to prevent the lock cylinder 120 from being rotated relative to the lock casing 110. In addition, the heights of the teeth of the key 200 correspond to variances in the total length of the second pins 134 and the setting pins 136 in the plurality of second pin holes 122. When the key 200 is inserted into the keyhole 124, the second pins 134 are configured push the first pins 132 toward the first pin holes 114, such that the first pins 132 no longer extend into the second pin holes 122 of the lock cylinder 120 (in other words, end surfaces of the plurality of first pins 132 facing the second pin holes 122 are aligned with a shear line between the lock cylinder 120 and the lock casing 110), so as to allow the lock cylinder 120 to rotate relative to the lock casing 110 for performing locking or unlocking operation. For example, the rekeyable lock 100 of the present invention can further comprise a transmission rod (not shown in figures) connected to the lock cylinder 120 for rotating with the lock cylinder 120. The transmission rod is configured to drive a latch to move when rotating, such as driving the latch to retract or extend relative to a door panel.

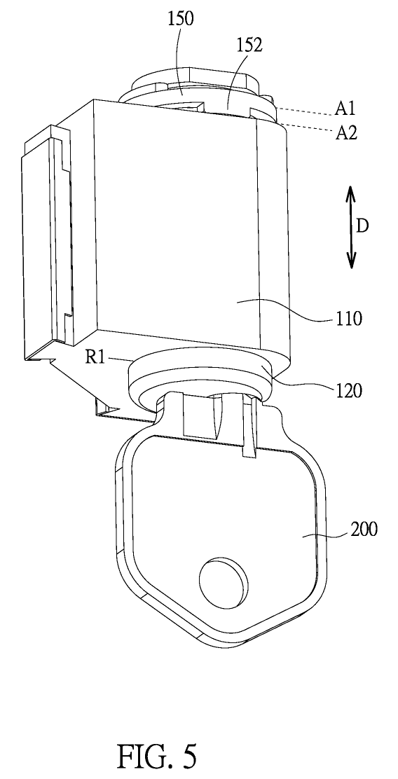

Please refer to FIG. 5. FIG. 5 is a diagram showing the lock cylinder 120 of the rekeyable lock 100 of the present invention located at the first rotating position R1 in another viewing angle. As shown in FIG. 5, the positioning ring 150 is formed with a protrusion part 152. When the lock cylinder 120 is located at the first rotating position R1 relative to the lock casing 110, the protrusion part 152 of the positioning ring 150 is configured to abut against the lock casing 110 in order to prevent the lock cylinder 120 from being moved relative to the lock casing 110 along an axial direction D of the lock cylinder 120 from a first axial position A1 to a second axial position A2 (in figures, a top surface of an edge of the lock cylinder 120 is used as a reference point for indicating the axial position of the lock cylinder 120). In other words, when the lock cylinder 120 is located at the first rotating position R1 relative to the lock casing 110, the lock cylinder 120 can only be located at the first axial position A1 along the axial direction D of the lock cylinder 120 relative to the lock casing 110.

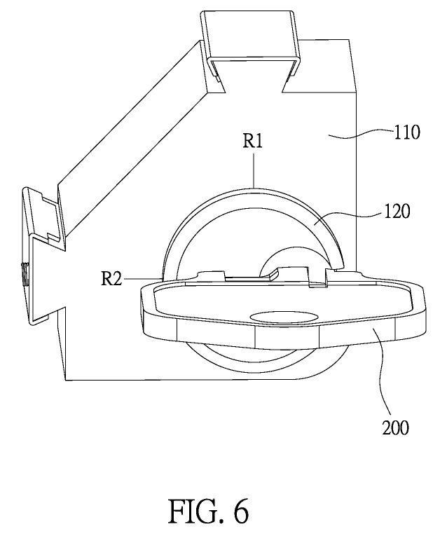

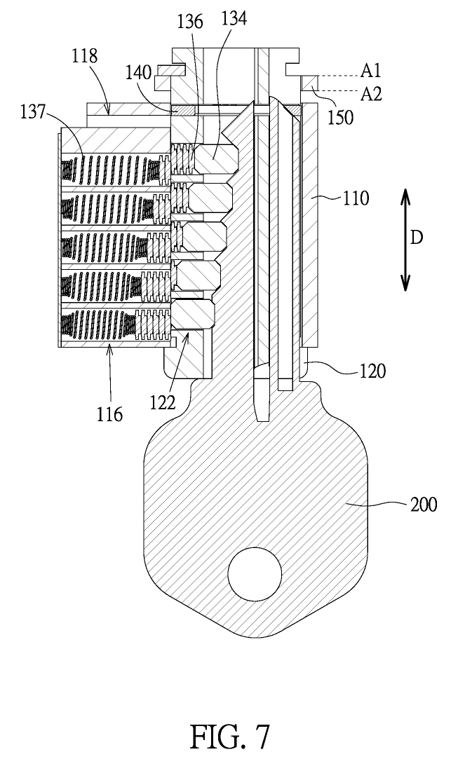

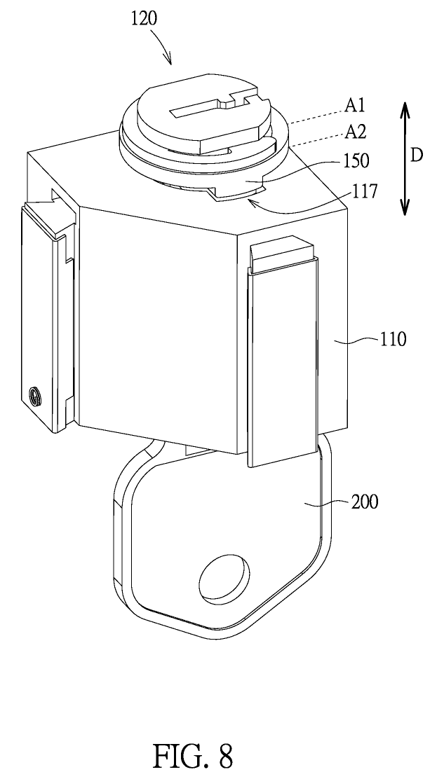

Please refer to FIG. 6 to FIG. 8. FIG. 6 is a diagram showing the lock cylinder 120 of the rekeyable lock 100 of the present invention being rotated from the first rotating position R1 to the second rotating position R2. FIG. 7 is a cross-sectional view of the lock cylinder 120 of the rekeyable lock 100 of the present invention located at the second rotating position R2 and the first axial position A1. FIG. 8 is a diagram showing the lock cylinder 120 of the rekeyable lock 100 of the present invention located at the second rotating position R2 and the first axial position A1 in another viewing angle. When a user uses the key 200 to rotate the lock cylinder 120 from the first rotating position R1 to the second rotating position R2 relative to the lock casing 110, the plurality of second pin holes 122 face toward and are misaligned with the plurality of setting holes 116 respectively, in order to prevent the plurality of setting pins 136 from being moved between the plurality of setting holes 116 and the plurality of second pin holes 122, such as preventing the setting pins 136 in the setting holes 116 from being moved into the second pin holes 122, or preventing the setting pins 136 in the second pin holes 122 from being moved into the setting holes 116. The above arrangement can prevent the user from accidentally resetting the lock 100 when rotating the lock cylinder 120 to perform locking or unlocking operation.

On the other hand, the lock casing 110 is formed with a first groove 117. As shown in FIG. 8, when the lock cylinder 120 is located at the second rotating position R2 relative to the lock casing 110, the protrusion part 152 of the positioning ring 150 corresponds to the first groove 117 of the lock casing 110, so as to allow the lock cylinder 120 to move relative to the lock casing 110 along the axial direction D of the lock cylinder 120 from the first axial position A1 to the second axial position A2. In other words, when the lock cylinder 120 is not located at the second rotating position R2 relative to the lock casing 110, the lock cylinder 120 cannot be moved relative to the lock casing 110 along the axial direction D of the lock cylinder 120 from the first axial position A1 to the second axial position A2.

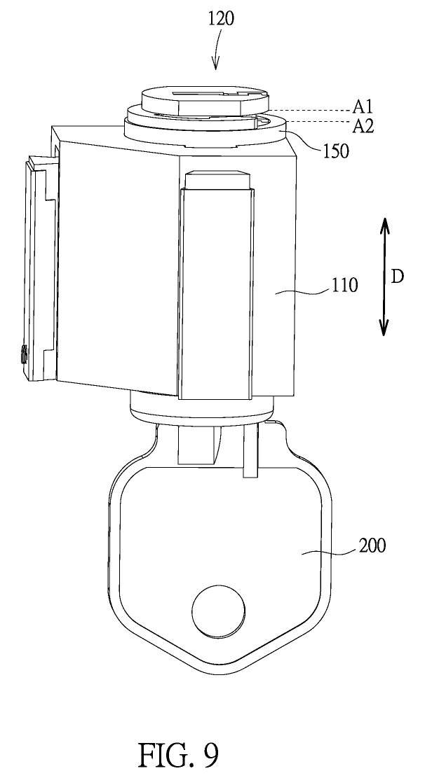

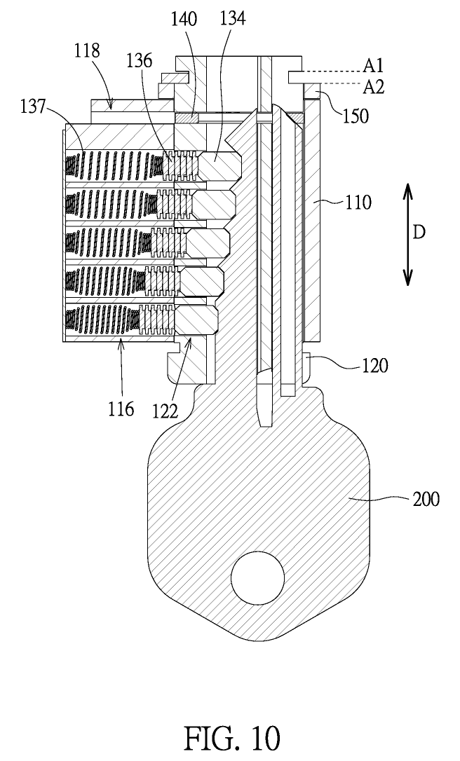

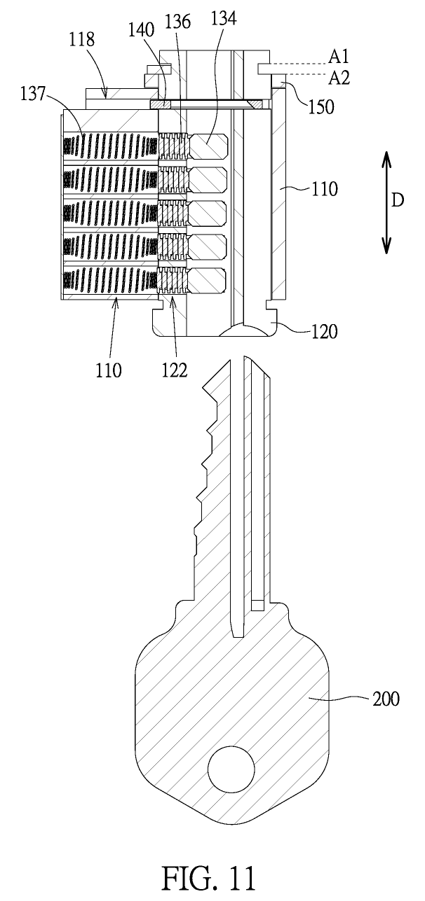

Please refer to FIG. 9 - FIG. 11. FIG. 9 is a diagram showing the lock cylinder 120 of the rekeyable lock 100 of the present invention located at the second rotating position R2 and the second axial position A2. FIG. 10 is a cross-sectional view of the lock cylinder 120 of the rekeyable lock 100 of the present invention located at the second rotating position R2 and the second axial position A2. FIG. 11 is a cross-sectional view of the lock cylinder 120 of the rekeyable lock 100 of the present invention located at the second rotating position R2 and the second axial position A2 with the key 200 being removed from the keyhole 124. When the user is going to reset the rekeyable lock 100, the user can further pull the key 200 outward from the lock cylinder 120 (which has been rotated to the second rotating position R2), so as to drive the lock cylinder 120 to move relative to the lock casing 110 along the axial direction D of the lock cylinder 120 from the first axial position A1 to the second axial position A2 (when the lock cylinder 120 is located at the first axial position A1, the second pin holes 122 are misaligned with the setting holes 116, such that the second pins 134 in the second pin holes 122 are configured to hinder pulling of the key 200 away from the lock cylinder 120, thus the pulling operation of the key 200 drives the lock cylinder 120 to move along the axial direction D until the lock cylinder 120 is moved relative to the lock casing 110 along the axial direction D from the first axial position A1 to the second axial position A2). On the other hand, the protrusion part 152 of the positioning ring 150 is configured to be inserted into the first groove 117 of the lock casing 110. When the lock cylinder 120 is located at the second rotating position R2 and the second axial position A2 relative to the lock casing 110, the key 200 can be moved relative to the lock cylinder 120 along the axial direction D to be removed from the keyhole 124. Correspondingly, when the lock cylinder 120 is located at the second rotating position R2 and the second axial position A2 relative to the lock casing 110, the plurality of second pin holes 122 are aligned with and communicated with the plurality of setting holes 116 respectively, so as to allow the plurality of setting pins 136 to move between the plurality of setting holes 116 and the plurality of second pin holes 122.

When the user inserts a new key with different heights of teeth into the keyhole 124 of the lock cylinder 120, the plurality of setting pins 136 are moved between the plurality of setting holes 116 and the plurality of second pin holes 122 according to the heights of teeth of the new key, such that the total length of the second pin 134 and the setting pins 136 in each of the second pin holes 122 corresponds to the height of corresponding tooth of the new key. The user then can uses the new key to move the lock cylinder 120 relative to the lock casing 110 along the axial direction D of the lock cylinder 120 from the second axial position A2 to the first axial position A1, and further uses the new key to rotate the lock cylinder 120 relative to the lock casing 110 from the second rotating position R2 to the first rotating position R1. Thereby, the resetting process of the rekeyable lock 100 is completed.

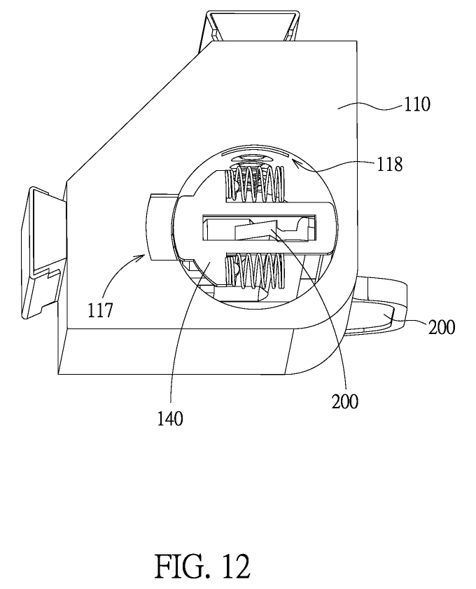

Please refer to FIG. 12, and refer to FIG. 3 - FIG. 4 and FIG. 10 - FIG. 11 as well. FIG. 12 is a diagram showing the lock casing 110 and the positioning piece 140 of the rekeyable lock 100 of the present invention. As shown in figures, in addition to the first groove 117, the lock casing 110 is further formed with a second groove 118. When the lock cylinder 120 is located at the first rotating position R1 relative to the lock casing 110, the positioning piece 140 is configured to be engaged with the first groove 117 in order to prevent the lock cylinder 120 from being rotated relative to the lock casing 110 (as shown in FIG. 3). On the other hand, when the lock cylinder 120 is located at the first rotating position R1 relative to the lock casing 110 with the key 200 being inserted into the keyhole 124, an inclined surface of a front end of the key 200 is configured to abut against one end of a slot in the middle of the positioning piece 140, such that the positioning piece 140 is driven to be disengaged from the first groove 117 (please refer to FIGS. 4 and 12) by overcoming elastic force of springs through the insertion of the key 200, so as to allow the lock cylinder 120 to rotate relative to the lock casing 110. When the lock cylinder 120 is located at the second rotating position R2 and the second axial position A2 relative to the lock casing 110, the positioning piece 140 is configured to be engaged with the second groove 118 in order to prevent the lock cylinder 120 from being rotated relative to the lock casing 110 (as shown in FIG. 11). On the other hand, when the lock cylinder 120 is located at the second rotating position R2 and the second axial position A2 relative to the lock casing 110 with the key 200 being inserted into the keyhole 124 to abut against the positioning piece 140, the positioning piece 140 is configured to be driven to disengage from the second groove 118 (as shown in FIG. 10).

When the lock cylinder 120 is located at the first rotating position R1 relative to the lock casing 110 without the key 200 being inserted into the lock cylinder 120, the positioning piece 140 is configured to be driven by the elastic force of the spring to be engaged with the first groove 117, so as to prevent the lock cylinder 120 from being rotated relative to the lock casing 110. As such, even if someone knocks the rekeyable lock 100 by a tool to make the plurality of first pins 132 jump relative to the second pin holes 122 to allow the end surfaces of the plurality of first pins 132 to be aligned with the shear line between the lock cylinder 120 and the lock casing 110, the lock cylinder 120 still cannot be rotated relative to the lock casing 110, so as to improve security of the rekeyable lock 100. During the resetting process of the rekeyable lock 100 (when the lock cylinder 120 is located at the second rotating position R2 and the second axial position A2 relative to the lock casing 110), the positioning piece 140 is configured to be driven by the elastic force of springs to be engaged with the second groove 118, so as to prevent the lock cylinder 120 from being rotated relative to the lock casing 110. The second groove 118 is located adjacent to an end of the lock casing 110. As such, before the key 200 is completely inserted into the lock cylinder 120, the lock cylinder 120 cannot be rotated relative to the lock casing 110, so as to prevent incorrect setting of the rekeyable lock 100 which may cause malfunction. In the present embodiment, both the first groove 117 and the second groove 118 are arranged. In other embodiments of the present invention, only one of the first groove 117 and the second groove 118 can be arranged according to requirements. In the embodiment of arranging only one of the first groove 117 and the second groove 118, the positioning piece 140 is constantly pressed when the positioning piece 140 is located at a position not corresponding to a groove.

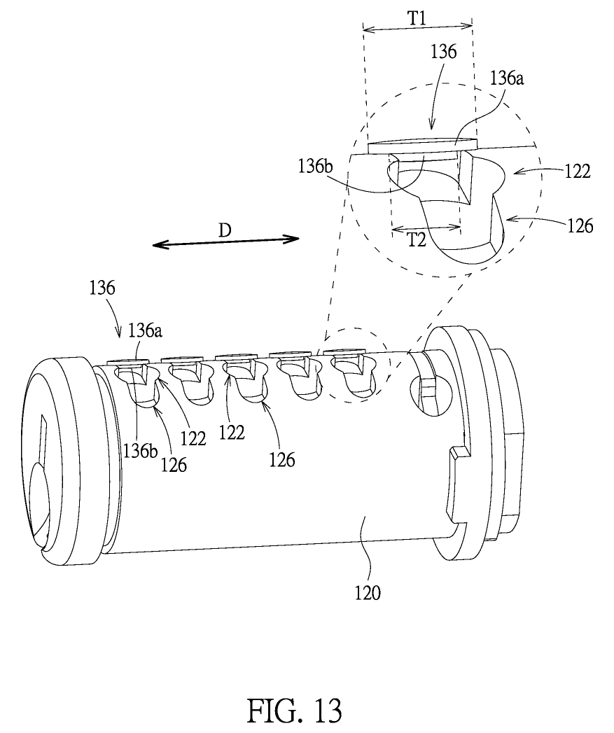

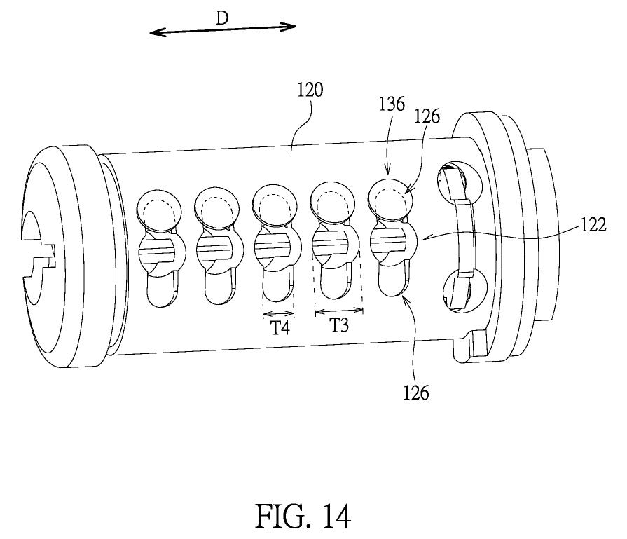

Please refer to FIG. 13 and FIG. 14. FIG. 13 is a diagram showing the lock cylinder 120 and the setting pins 136 of the present invention. FIG. 14 is a diagram showing the lock cylinder 120 and the setting pins 136 of the present invention in another viewing angle. As shown in figures, the lock cylinder 120 is further formed with a plurality of anti-theft grooves 126 respectively communicated with the plurality of second pin holes 122. A maximum dimension T4 of the anti-theft groove 126 along the axial direction D of the lock cylinder 120 is smaller than a maximum dimension T3 of the second pin hole 122 along the axial direction D of the lock cylinder 120. Furthermore, the setting pin 136 comprises a top part 136a and a bottom part 136b. A maximum dimension T1 of the top part 136a of the setting pin 136 along the axial direction D of the lock cylinder 120 is greater than the maximum dimension T4 of the anti-theft groove 126 along the axial direction D of the lock cylinder 120. A maximum dimension T2 of the bottom part 136b of the setting pin 136 along the axial direction D of the lock cylinder 120 is not greater than the maximum dimension T4 of the anti-theft groove 126 along the axial direction D of the lock cylinder 120. In the present embodiment, each of the second pin holes 122 is communicated with two anti-theft grooves 126, which are formed at opposite sides of the second pin hole 122. Each of the setting pins 136 in FIG. 13 is located in the anti-theft groove 126 at one side of the second pin hole 122.

According to the above arrangement, when someone attempts to unlock the rekeyable lock 100 by using a key with incorrect heights of teeth, the lock cylinder 120 cannot be rotated relative to the lock casing 110 if any of the first pins 132 passes through the shear line between the lock cylinder 120 and the lock casing 110. When the incorrect key pushes all of the first pins 132 and at least one setting pin 136 into the first pin holes 114, the shear line between the lock cylinder 120 and the lock casing 110 is aligned with a contact surface between the two setting pins 136 (or aligned with a contact surface between the setting pin 136 and the second pin 134), such that the lock cylinder 120 can be rotated relative to the lock casing 110. However, when the lock cylinder 120 is rotated to move the anti-theft groove 126 to align with the first pin hole 114, the bottom part 136b of the setting pin 136 located in the first pin hole 114 is configured to be pushed by the pin spring 133 to be extended into the anti-theft groove 126 with the top part 136a of the setting pin 136 being accommodated in the first pin hole 114, so as to prevent the lock cylinder 120 from being further rotated. Therefore, the key with the incorrect heights of teeth cannot rotate the lock cylinder 120 for performing locking or unlocking operation.

In contrast to the prior art, the resetting process of the rekeyable lock 100 of the present invention is performed by rotating and axially moving the lock cylinder 120. The resetting process of the rekeyable lock 100 of the present invention is not only simple but also capable of preventing misoperation. Furthermore, the rekeyable lock 100 of the present invention can prevent abnormal unlocking operation by knocking with the tool or by using a key with incorrect heights of teeth, such that the security of the rekeyable lock 100 of the present invention is enhanced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A rekeyable lock, comprising
a lock casing formed with a lock cylinder hole, a plurality of first pin holes and a plurality of setting holes;
a lock cylinder rotatably arranged in the lock cylinder hole and formed with a plurality of second pin holes; and
a pin set, comprising:
a plurality of first pins accommodated in the plurality of first pin holes respectively;
a plurality of second pins accommodated in the plurality of second pin holes respectively; and
a plurality of setting pins, wherein each of the setting holes is configured to accommodate a predetermined number of setting pins;
wherein when the lock cylinder is located at a first rotating position relative to the lock casing, the plurality of second pin holes are aligned with the plurality of first pin holes respectively;
wherein when the lock cylinder is rotated relative to the lock casing from the first rotating position to a second rotating position, the plurality of second pin holes face toward and are misaligned with the setting holes respectively, so as to prevent the plurality of setting pins from being moved between the plurality of setting holes and the plurality of second pin holes;
wherein when the lock cylinder is located at the second rotating position and further moved relative to the lock casing from a first axial position to a second axial position along an axial direction of the lock cylinder, the plurality of second pin holes are aligned with the setting holes respectively, so as to allow the plurality of setting pins to be moved between the plurality of setting holes and the plurality of second pin holes.

2. The rekeyable lock of claim 1, further comprising a positioning piece movably arranged on the lock cylinder, wherein the lock casing is formed with a groove; wherein when the lock cylinder is located at the first rotating position relative to the lock casing, the positioning piece is configured to be engaged with the groove to prevent the lock cylinder from being rotated relative to the lock casing.

3. The rekeyable lock of claim 2, further comprising a positioning ring arranged on the lock cylinder; wherein the positioning ring is formed with a protrusion part; wherein when the lock cylinder is located at the first rotating position relative to the lock casing, the protrusion part is configured to abut against the lock casing to prevent the lock cylinder from being moved relative to the lock casing from the first axial position to the second axial position along the axial direction of the lock cylinder.

4. The rekeyable lock of claim 3, wherein when the lock cylinder is located at the second rotating position relative to the lock casing, the protrusion part corresponds to the groove to allow the lock cylinder to be moved relative to the lock casing from the first axial position to the second axial position along the axial direction of the lock cylinder.

5. The rekeyable lock of claim 1, further comprising a positioning piece movably arranged on the lock cylinder, wherein the lock casing is formed with a groove; wherein when the lock cylinder is located at the second rotating position and the second axial position relative to the lock casing, the positioning piece is configured to be engaged with the groove to prevent the lock cylinder from being rotated relative to the lock casing.

6. The rekeyable lock of claim 5, wherein the lock cylinder is further formed with a keyhole communicated with the plurality of second pin holes; wherein when the lock cylinder is located at the second rotating position and the second axial position relative to the lock casing and when a key is inserted into the keyhole to abut against the positioning piece, the positioning piece is configured to be driven to disengage from the groove.

7. The rekeyable lock of claim 1, wherein the lock cylinder is further formed with a plurality of anti-theft grooves respectively communicated with the plurality of second pin holes; wherein a maximum dimension of the anti-theft groove along the axial direction of the lock cylinder is smaller than a maximum dimension of the second pin hole along the axial direction of the lock cylinder.

8. The rekeyable lock of claim 7, wherein the setting pin comprises a top part and a bottom part, wherein a maximum dimension of the top part along the axial direction of the lock cylinder is greater than the maximum dimension of the anti-theft groove along the axial direction of the lock cylinder, and a maximum dimension of the bottom part along the axial direction of the lock cylinder is not greater than the maximum dimension of the anti-theft groove along the axial direction of the lock cylinder.

9. The rekeyable lock of claim 1, wherein the pin set further comprises a plurality of pin springs respectively accommodated in the plurality of first pin holes and configured to push the plurality of first pins to move toward the lock cylinder.

10. The rekeyable lock of claim 1, wherein the pin set further comprises a plurality of setting springs respectively accommodated in the plurality of setting holes and configured to push the plurality of setting pins to move toward the lock cylinder.
